(19) United States
(12) Patent Application Publication
(10) Pub. No.: US 2002/0098382 A1
(43) Pub. Date: Jul. 25, 2002

(54) Magnetic recording device

(76) Inventors: Seong-rae Lee, Seoul (KR); Young-keun Kim, Seoul (KR); Sang-hyun Yang, Chungcheongbuk-do (KR)

Correspondence Address: ROTHWELL, FIGG, ERNST & MANBECK, P.C., 1425 K STREET, N.W., SUITE 800, WASHINGTON, DC, 20005, US

(21) Appl. No.: 09/859,527

(22) Filed: May 18, 2001

(30) Foreign Application Priority Data
Nov. 20, 2000 (KR) 00-69017

(51) Int. Cl. G11B 5/65; B32B 3/02

(52) U.S. Cl. 428/694 T

(57) ABSTRACT

A magnetic recording media for improving information storage density by adding Zr to a FePt film used in an information storage unit is provided. In the magnetic recording media including an information recording means for recording information and an information storage means for storing the information magnetically recorded by the information recording means, the information storage means includes a FePt magnetic layer containing Zr on the substrate. Thus, the use of a FePt—Zr film provides an information storage media having fast phase transformation a high coercivity and a fine grain size compared to the use of a FePt film.

### BACKGROUND OF THE INVENTION

1. Field of the Invention

The present invention relates to a magnetic recording media, and more particularly, to a magnetic recording media for attaining high information storage density by adding Zr to a FePt film included in an information storage unit.

2. Description of the Related Art

For materials to be used in a magnetic recording media for recording information, the materials must have high coercivities and fine grain sizes. However, if magnetic recording materials grown are subjected to annealing, grain sizes as well as coercivities increase due to the annealing. Since each information unit is formed of grains, smaller grains results in smaller information units and higher density magnetic recording.

A typical magnetic recording media includes an information recording unit for recording information and an information storage unit for storing information. For example, the information recording unit may be a head within a computer hard disk drive, and the information storage unit may be a magnetic recording medium including magnetic materials. In this case, the information storage unit consists of a magnetic layer on an Al—Mg alloy or a glass substrate and a protective layer for protecting the magnetic layer and a lubricant layer for minimizing a friction with the head overlying the magnetic layer. Here, the magnetic layer formed of a magnetic material stores information, and the information is stored and reproduced by means of a head.

Most recently, reducing grain sizes while maintaining thermal stability of grain is very important for storing information with high areal density. High crystal magnetic anisotropy of a material increases thermal stability thereof. A FePt thin film having an ordered structure has received considerable attention in terms of thermal stability due to high crystal magnetic anisotropy. For example, the FePt thin film may be used as a magnetic recording material for storing a spin of a disk. A deposited FePt film has a disordered face centered cubic (fcc) structure, but the FePt film subjected to annealing has an ordered face centered tetragonal (fct) structure with high crystal anisotropy and coercivity.

As described above, the FePt thin film has high coercivity but large grain size after annealing. Thus, present magnetic recording technologies using the FePt film highly depends on annealing conditions and cannot simultaneously provide high coercivities and smaller grain sizes.

### SUMMARY OF THE INVENTION

To solve the above problems, it is an object to provide a material having a high coercivity while reducing the grain growth during annealing of a FePt film used as a material of a magnetic recording medium.

Accordingly, to achieve the above object, the present invention provides a magnetic recording media consisting of an information recording means for recording information and an information storage means for storing the information magnetically recorded by the information recording means. In the magnetic recording media, the information storage means includes a substrate, a FePt magnetic layer containing Zr on the substrate, and a protective layer overlying the magnetic layer.

Preferably, the information storage means further includes a buffer layer formed between the substrate and the magnetic layer.

Preferably, the protective layer is an anti-oxidative layer for preventing oxidation of the magnetic layer.

Preferably, the protective layer is a lubricant layer for minimizing a friction with the information recording means when the protective layer is in contact with the information recording means.

### BRIEF DESCRIPTION OF THE DRAWINGS

The above object and advantages of the present invention will become more apparent by describing in detail preferred embodiments thereof with reference to the attached drawings in which:

FIG. 1 schematically shows a magnetic recording media for storing information according to the present invention;

FIG. 2 is a graph showing changes in a (111) d-spacing of FePt—Zr with respect to the amount of Zr (at. %) when Zr is added to a FePt thin film used for the device of FIG. 1;

FIG. 3 is a graph showing changes in coercivities of FePt and FePt—Zr films with respect to an annealing time when the films are annealed at about 500° C.;

FIG. 4 is a graph showing changes in an X-ray diffraction (XRD) pattern of a FePt film with respect to an annealing time when the FePt film is annealed at about 500° C.;

FIG. 5 is a graph showing changes in an XRD pattern of a FePt—Zr thin film with respect to an amount (at. %) of Zr added when the FePt—Zr film is annealed at about 500° C. for 10 minutes;

FIG. 6 is a graph of changes in an XRD pattern of FePt—Zr film with respect to an annealing time when 3 at. % Zr is added at a FePt film;

FIGS. 7A-7D are transmission electron microscopy (TEM) micrographs of a FePt film under different annealing conditions;

FIGS. 7E-7H are TEM micrographs of a FePt—Zr film under different annealing conditions;

FIG. 8 is a graph showing changes in an average grain size (nm) of FePt—Zr film with respect to an annealing time and an amount of Zr added; and

FIG. 9 is a graph showing changes in the coercivity of a FePt—Zr film, subjected to annealing at about 500° C., after having been deposited using a fixed content 3 at. % Zr and varying amounts of Fe and Pt, with respect to annealing time.

### DETAILED DESCRIPTION OF THE INVENTION

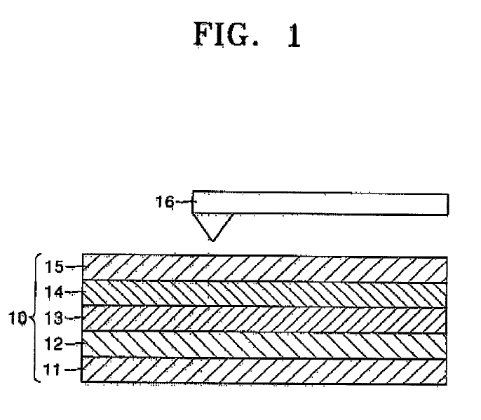

Referring to FIG. 1, a magnetic recording media according to the present invention includes an information storage unit 10 and an information recording unit 16. Here, the information storage unit 10 has a structure in which a magnetic layer 13 is formed on a substrate 11. Also, the information storage unit 10 may further include a buffer layer 12, a protective layer 14 for protecting the magnetic layer 13, and a lubricant layer 15 for reducing a friction with the information recording means 16 such as a head. In this case, the magnetic layer 13 stores information by means of the head.

The magnetic layer 13 is the most important component in the information storage unit 10. The feature of this invention is that a FePt—Zr film is used as a material of the magnetic layer 13 included in the information storage unit 10. The physical properties of a FePt—Zr film will now be described in detail with reference to the attached drawings.

In an embodiment of the present invention, a FePt—Zr film is deposited using a 4 target dc magnetron sputtering by a downward sputtering apparatus. Measurements of a vacuum level are made by an ion gauge and a thermocouple gauge. An initial vacuum level before deposition is no greater than 4×10⁻⁷ Torr, and Ar having a purity of 99.9999% is used as a sputtering gas.

The FePt—Zr film is formed by sputtering using an Fe target having a diameter of 10 cm and Pt and Zr chips. Samples were prepared by depositing a monolayer of FePt—Zr on a corning glass substrate having a size of 12×12 mm under the same conditions, 200 W, 2 mTorr, and 70 nm. Native oxides and contaminants were removed from the substrate before this deposition by an ultrasonic washer using a cleaning solution in the order of a soapy water, trichloroethane, acetone, and alcohol. For post-deposition annealing, FePt and FePt—Zr are simultaneously annealed in a vacuum of 6×10⁻⁶ or less at 500° C. for a variety of different time durations and are then cooled using air cooling in a vacuum.

In an embodiment of the present invention, the magnetic properties of a thin film are measured at room temperature using a vibrating sample magnetometer (VSM) Lake Shore 735. The crystal structure and orientation are observed through an X-ray diffraction (XRD) pattern and a transmission electron microscopy (TEM) selected area diffraction (SAD) pattern, and microscopic structures such as a crystal grain size are observed using TEM.

Grain sizes of all samples are observed using TEM and then analyzed with a phase analyzer. Film compositions are determined through an inductively coupled plasma (ICP) analysis. Furthermore, the thickness of a thin film is measured by a film thickness meter α-STEP. To reduce an allowable range of errors, a thin film is formed with a thickness of greater than 3,000 Å.

FIG. 2 shows changes in a (111) d-spacing of an FePt—Zr film with respect to an amount at. % of Zr added when Zr is added to FePt. As shown in FIG. 2, the (111) d-spacing increases as the content of Zr increases. An FePt—Zr film attains a structure denser than a bulk state after sputter deposition and a larger d-spacing due to the addition of Zr impurities. When Zr is added, as a result of XRD analysis to confirm a structural transformation of samples before annealing, a preferred (111) plane orientation is observed in the samples. This is because (111), which is the densest plane of a face centered cubic (fcc) structure, is grown on a substrate with priority in order to reduce an interface energy thereby forming a texture. Furthermore, no anisotropy is shown within the (111) plane. It is considered that sputter deposition allows the deposited film to have a structure denser than a bulk state and the addition of Zr impurities increases d-spacing.

The as-deposited film has a typical disordered fee structure regardless of addition of Zr. Grain sizes of films containing Zr and containing no Zr are measured to be 4 and 3 nm, respectively. That is, samples containing Zr have a smaller grain size.

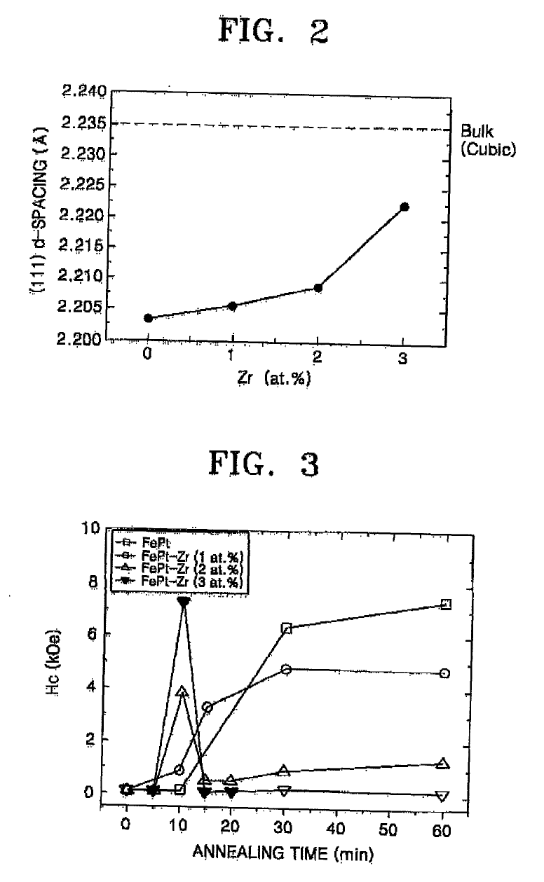

FIG. 3 shows variations in coercivities of FePt and FePt—Zr films with respect to an annealing time when the films are annealed at 500° C. Here, the coercivity of FePt—Zr film are measured when a Zr content is 1, 2, and 3 at. %, respectively. A FePt film containing no Zr has a larger coercivity as an annealing time increases. No significant change is coercivity occurs within 10 minutes but after 10 minute annealing, the coercivity of the FePt film increases sharply to be gradually saturated. After annealing at about 500° C. for 30 minutes, the FePt film has a coercivity of 6,400 Oe and a grain size of 25 nm. On the other hand, a film, to which Zr of about 3 at. % is added, has a coercivity greater than about 7,000 Oe only with 10 minute annealing. Thus, the FePt—Zr film and the FePt film have different magnetic properties. In the FePt—Zr film, the rate of change in intial coercivity varies depending on the Zr content, and the coercivity thereof decrease after a threshold time lapses. That is, as the Zr content increases, the coercivity of the FePt—Zr film significantly increases during initial annealing and a threshold time at which the cocercivity begins to decrease becomes shorter.

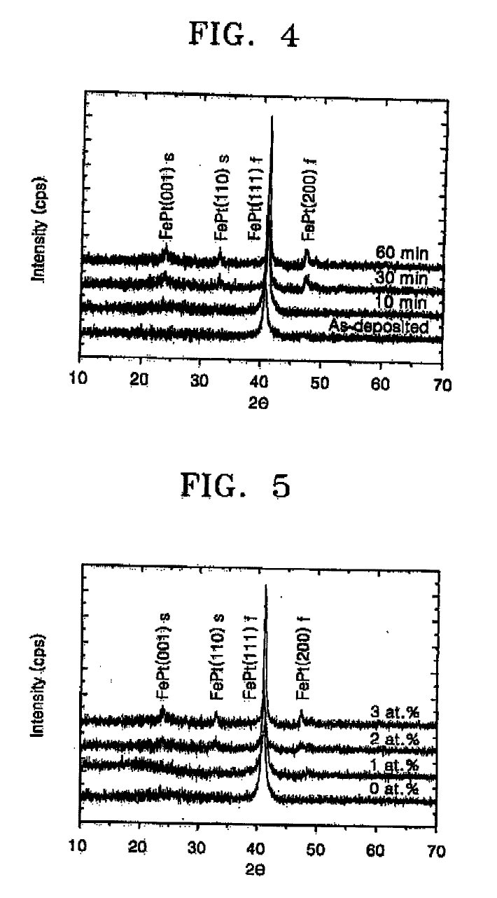

FIG. 4 shows changes in an XRD pattern of an FePt film with respect to an annealing time when the FePt film is annealed at about 500° C. Since a c-axis is a magnetic easy axis in an ordered face centered tetragonal (fct) structure, a preferred (111) plane orientation means that an in-plane coercivity is larger than a vertical coercivity. After annealing of the FePt film for about 10 minutes, superlattice peaks (001) and (110) appear in annealed samples. This is due to the structural transformation from a disordered fcc or fct phase of the as-deposited film to an ordered fct phase having a high crystal magnetic anisotropy. Thus, it is considered that increased coercivity due to increased annealing time are significantly affected by an increase in the rate of a phase transition to an ordered fct FePt structure.

FIG. 5 shows changes in an XRD pattern of a FePt—Zr film according to the present invention with respect to an amount at. % of Zr added when the FePt—Zr film is annealed at about 500° C. for 10 minutes. When 0 and 1 at. % Zr is added, the film has a disordered fcc structure in which only a (111) plane is developed. When 2 at. % Zr is added, superlattice peaks (001) and (110) appears weak, and when 3 at. % Zr is added, the superlattice peaks (001) and (110) appears strong. This means that the structural transformation of fcc to fct having a high coercivity occurs largely as the Zr content increases. Furthermore, as the Zr content increases, a d-spacing of the (111) plane further approaches a corresponding d-spacing of an ordered crystal structure. Thus, an increase in the Zr cotent results in a faster intial phase transition. The sharply increasing initial coercivity is due to the faster phase tranformation.

A (111) d-spacing variation with respect to an additive amount of Zr and an annealing time is measured as shown in Table 1.

TABLE 1

| | 0 (Zr at. %) | 1 | 2 | 3 |
|---|---|---|---|---|
| 0 min | 2.2035 | 2.2057 | 2.2089 | 2.2221 |
| 10 min | 2.2024 | 2.1897 | 2.1888 | 2.1923 |

Table 1 shows changes in d-spacing (Å) with respect to Zr content (at. %) and annealing time.

FIG. 6 shows changes in a XRD pattern of a sample, to which about 3 at. % Zr is added, with respect to annealing time. The as-deposited sample has a fcc FePt structure. However, after annealing of the as-deposited sample for 10 minutes, superlattice peaks (001) and (110) are observed in the XRD pattern, and then the superlattice peaks (001) and (110) disappears and the annealed sample has a fcc FePt structure. Since a fct structure having superlattice peaks has a high coercivity, a phase transition, which occurs to an increasing extent as annealing time increases, results in an increase in coercivity. Thus, the addition of Zr accelerates a phase change to fct during initial annealing, and changes the fct to fcc structure after a threshold time lapses.

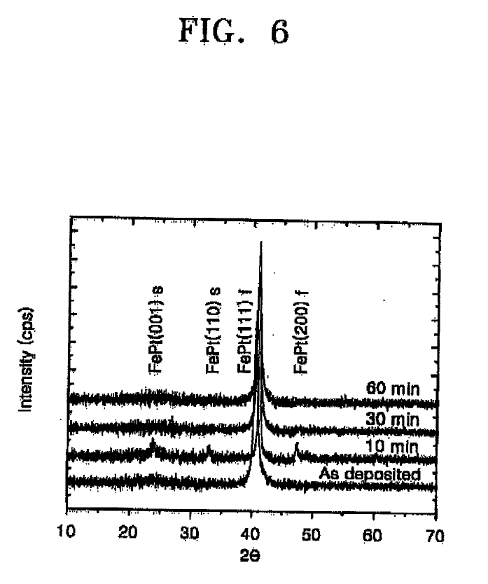

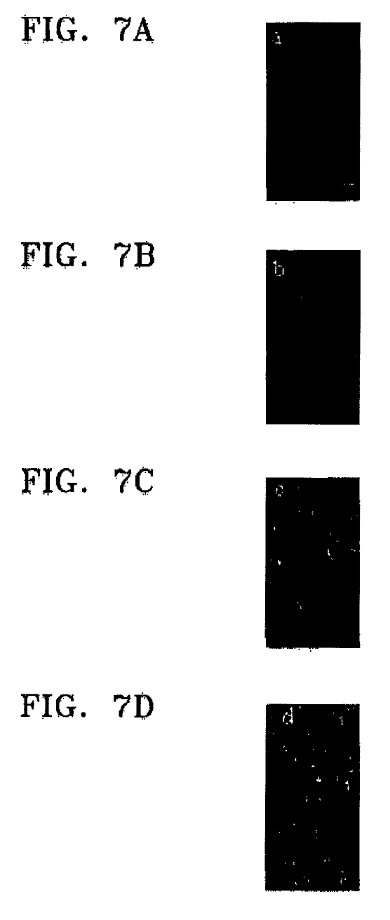

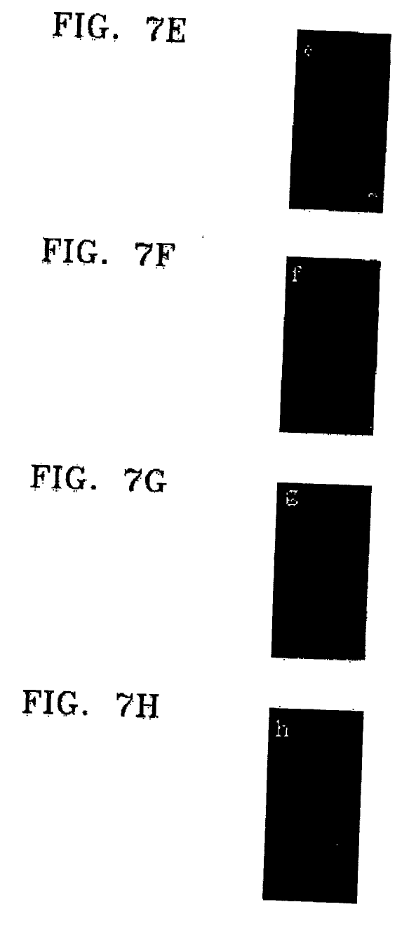

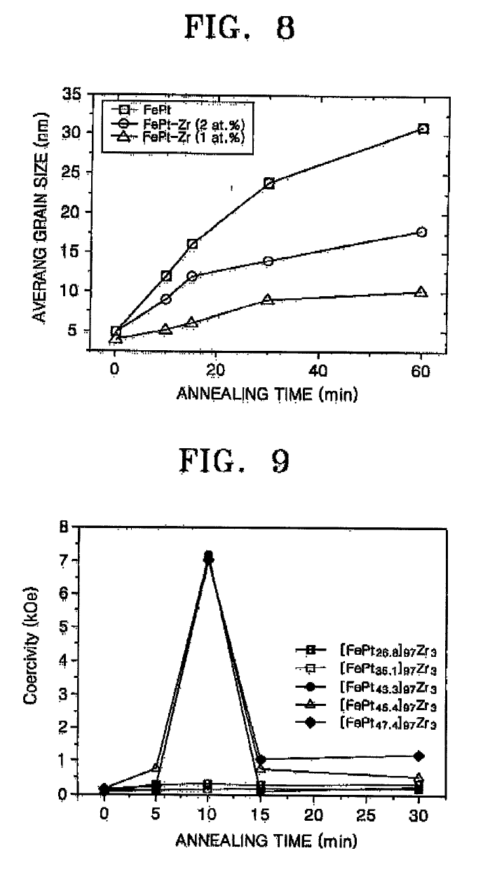

FIGS. 7A-7H are TEM micrographs of samples. Here, FIGS. 7A-7D are micropgrahs of a FePt film, and FIGS. 7E-7H are micrographs of a FePt—Zr (3 at. %) film. The films in FIGS. 7A and 7E were not annealed, and the films in FIGS. 7B and 7F are annealed at about 500° C. for about 10 minutes. The films in FIGS. 7C and 7G are annealed at the same temperature for about 20 minutes, and the films in FIGS. 7D and 7H are annealed at the same temperature for about 30 minutes. As evident from FIGS. 7A-7H, as a result of comparison between the FePt and FePt—Zr films, the FePt—Zr films can obtain even denser microstructures.

FIG. 8 shows variations in average grain sizes (nm) of a FePt—Zr film with respect to annealing time and amount (at. %) of Zr added. As evident from a graph of FIG. 8, as annealing time increases, the grain growth is further retarded due to higher thermal energy so the film has a smaller grain size. That is, when a comparison is made between FePt and FePt—Zr films, it is noticed that the grain size is finer as a Zr addition amount increases.

FIG. 9 shows changes in the coercivity of a FePt—Zr film, subjected to annealing at about 500° C. after having been deposited using a fixed content 3 at. % Zr and varying amounts of Fe and Pt, with respect to annealing time. By annealing the FePt—Zr film for about 10 minutes, a coercivity of about 7 kOe is obtained when a Pt content is greater than 43.3 at. %. Hower, a lower coercivity is obtained when the Pt content is less than that. As a result of XRD analysis, a phase transition to an ordered structure having diffraction peaks of (001) and (110) planes occurs when the Pt content is high after about 10 minute annealing, and then the ordered phase disappers. Furthermore, as the Pt content increases, a speed at which the ordered phase disappears is decreased, and a preferred orientation in a (110) direction is confirmed.

This invention has several advantages. First, the addition of Zr to a FePt film accelerates a phase transition from a disordered fcc FePt structure to an ordered fct FePt structure, and the phase transition speed increases as the amount of Zr added increases. This allows the FePt—Zr film to obtain an ordered phase faster than FePt and a coercivity in excess of about 7,000 Oe when about 3 at. % Zr is added. This faster phase transition is caused by the fact that defects in the film works on an ordered phase of FePt as a necleation source. Second, although the addition of Zr to a FePt film expedites a phase transition to an ordered phase during initial annealing, the ordered phase disappears after annealing more than a threshold time. This is because thermal energy in excess of a threshold causes a chemical reaction of Zr with Fe or Pt to deviate from a requisite composition range of the ordered phase. As described above, if a phase change to an ordered phase is made when the Pt content is high, the ordered phase disappears slowly. This is due to the chemical combination of Zr with Pt. Furthermore, as the Pt content increases, a preferred orientation in the (110) direction is shown.

Lastly, the addition of Zr to the FePt film prevents a grain growth during annealing for making a phase change to an ordered fct FePt structure. As the amount of Zr added increases, the grain growth is further delayed so that the film has a finer grain size. A sample containing 3 at. % Zr and having a coercivity of 7,146 Oe has a small grain size of the order of 6 nm, whereas a sample containing no Zr and having a coercivity of about 7,000 Oe has a very large grain size of the order of 30 nm.

Accordingly, the use of a FePt—Zr film according to the present provides an information storage media having a high coercivity and a fine grain size compared to a conventional FePt. This significantly improves information storage density and signal-to-noise (S/N) ratio in the information storage media.

What is claimed is:

1. A magnetic recording media including an information recording means for recording information and an information storage means for storing the information magnetically recorded by the information recording means, wherein the information storage means comprises:
a substrate;
a FePt magnetic layer containing Zr on the substrate; and
a protective layer overlying the magnetic layer.

2. The magnetic recording media of claim 1, wherein the information storage means further comprises a buffer layer formed between the substrate and the magnetic layer.

3. The magnetic recording media of claim 1, wherein the protective layer is an anti-oxidative layer for preventing oxidation of the magnetic layer.

4. The magnetic recording media of claim 1, wherein the protective layer is a lubricant layer for minimizing a friction with the information recording means when the protective layer is in contact with the information recording means.
